(19) United States
(12) Patent Application Publication
(10) Pub. No.: US 2015/0108143 A1
(43) Pub. Date: Apr. 23, 2015

(54) Cookware Having a Tread Plate Surface

(71) Applicant: All-Clad Metalcrafters LLC, Canonsburg, PA (US)

(72) Inventor: William A. Groll, McMurray, PA (US)

(21) Appl. No.: 14/520,622

(22) Filed: Oct. 22, 2014

Related U.S. Application Data
(60) Provisional application No. 61/893,960, filed on Oct. 22, 2013.

(51) Int. Cl. A47J 36/02; B23K 31/02; A47J 37/10; B21D 51/18; B21D 26/021

(52) U.S. Cl. CPC A47J 36/025; B21D 51/18; B21D 26/021; A47J 37/108; B23K 31/02
USPC 220/573.2; 72/55; 29/527.4; 228/170

(57) ABSTRACT

Cookware formed from a metal tread plate wherein the metal tread plate is one of carbon steel, aluminum, or stainless steel. The cookware is in the form of a fry pan, roaster pan, saucepan and the like, particularly for outdoor cooking.

### CROSS-REFERENCE TO RELATED APPLICATIONS

This application is a non-provisional application of and claims priority to U.S. Provisional Application No. 61/893,960 filed Oct. 22, 2013.

### BACKGROUND OF THE INVENTION

1. Field of the Invention

The present invention relates to outdoor cookware having an interior (cooking) surface made from a tread plate or checkered plate and to methods of making such cookware.

2. Description of Related Art

It is well known to use cast iron, carbon steel, or perforated stainless steel in the manufacture of outdoor cookware. These materials are better suited to handle the higher temperatures experienced in outdoor grills than commonly used indoor cookware. Known outdoor cookware includes cast iron or steel roasters, griddles, grills, fry pans and the like. All of this cookware has a relatively smooth inside interior, except perhaps the grill pan, which has a plurality of parallel, raised spaced-apart ribs extending along the cook surface. The raised ribs of the grill pan or plate impart sear lines on the food being cooked to add an attractive appearance to the food. The cast iron griddles and grill pans or plates are usually cast in a mold and sometimes coated with a porcelain enamel in various colors for improved appearance. Typical shapes are round, square, oval, or rectangular and usually have cast handles associated therewith. The carbon steel outdoor cookware may have handles which are attached as by welding to the steel pan.

It is well known that cast iron and carbon steel are prone to rusting, and it is, likewise, known to treat the exposed surfaces of such cookware with various coatings to prevent rust from forming as well as to improve clean-up problems by imparting a non-stick type of surface to the cookware. This type of surface treatment is referred to as “curing” cast iron cookware and, in itself, is well known in the cookware art.

Steel tread or floor plate, also known as steel diamond plate or checkered plate, is well known in applications such as trailer and truck bed flooring, running boards, ramps, walkways, stair treads, and the like. To my knowledge, such tread plate has not been used heretofore in cookware constructions.

### SUMMARY OF THE INVENTION

Briefly stated, the present invention relates to cookware, preferably for outdoor use, formed from a metal plate having a tread plate surface on one side which is preferably on the food-contacting, cooking side. The metal is preferably carbon steel with a black finish, but could also be one of aluminum or stainless steel tread plate. The tread plate is nominally about ⅛ inch in thickness but could range between as low as 1/16 inch up to about ¼ inch in thickness. At these heavier thicknesses, the steel plate is difficult to form into a pan shape, as by deep drawing, which is conventional when making cookware shapes. In one embodiment of the present invention, the plate is first cut into a blank shape of desired size, preferably by laser cutting. The cuts are made outwardly from a flat central portion of the blank which defines the closed bottom wall or cook surface of the cookware to be formed. The cut portions are then bent upwardly, preferably in a press brake device, to form the sidewalls of the cookware. The seams along the edges of the adjacent cut portions of the sidewalls are then welded to form a liquid-tight interior for the cookware. Additional steel material may be left on end portions of the blank at an outer perimeter thereof to form integral grip handles at desired locations for the cookware, also by laser cutting. The handles are also bent to shape with the press brake after the cut portions are bent to form the sidewalls.

In another embodiment of the present invention, the tread plate is cut into a flat blank shape of desired size by laser cutting or other technique. The tread plate blank is then placed in blow-down hydro-forming apparatus and formed into a desired cookware shape in a single forming step. This hydro-forming method makes it possible to produce a desired cookware shape without the necessity of cutting, bending, and welding the corner portions, as in the first-described embodiment.

The formed carbon steel cookware may then be seasoned by coating with a mineral or vegetable oil or lard and then thermally treated in an oven. A presently preferred curing temperature is about 600° F. The formed cookware may alternatively be given a coating of ceramic or vitreous enamel as a non-stick and protective finish. The finished, cured or coated surfaces of the steel cookware are preferably black in color, which improves the heat absorption properties of the cookware, provides non-stick properties and corrosion resistance, particularly against rusting. Various coating colors are also possible, if desired.

The outwardly extending lugs of the embossed tread plate on the inside (cook surface) of the cookware act as spacers for the food product being cooked to raise the food from direct contact with the flat areas between the vertically raised lugs. In this manner, the food product does not lie in the grease collected at the bottom of the cookware so as to improve the cooking performance. The raised lugs also provide a unique seared appearance to the cooked food product.

### BRIEF DESCRIPTION OF THE DRAWINGS

FIG. 1 is a drawing of a roasting pan of a welded embodiment of the present invention taken in a top perspective view;

FIG. 2 is a drawing of a saucepan, welded embodiment of the present invention, without a handle attached;

FIG. 3 is a drawing of a deep fry pan, welded embodiment of the present invention, without the handle;

FIG. 4 is a drawing taken as a top perspective view of the hydro-formed embodiment of another embodiment of the present invention in the shape of fry pan, with handles attached;

FIG. 5 is a drawing similar to FIG. 4 showing a hydro-formed embodiment of the invention in the shape of a roasting pan with flared edges;

FIG. 6 is a drawing of the fry pan of FIG. 4 in an inverted position showing the exterior surface as having an embossed surface on the tread plate; and

FIGS. 7-9 are cross-sectioned schematic drawings of a blow-down hydro-forming operation used in the manufacture of the cookware shown in FIGS. 4-6.

### DETAILED DESCRIPTION OF THE INVENTION

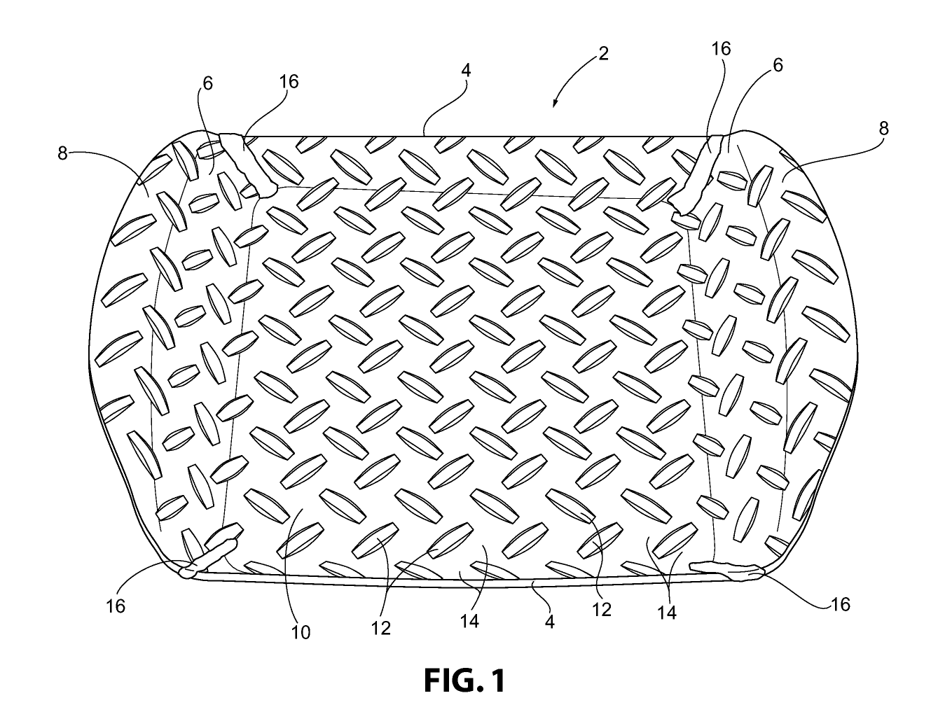

With reference to the drawings, FIG. 1 depicts one presently preferred embodiment of the cookware of the invention in the shape of a roasting pan 2. The roasting pan 2 is rectangular in shape having long sidewalls 4 and narrow sidewalls 6 with a length of about 12-½ inches, a width of about 9-½ inches, and a depth of about 2-¾ inches. Of course, it will be understood that these dimensions are for illustrative purposes only for one presently preferred embodiment and could be varied. In addition, the plan view shape of the roasting pan 2 need not be limited to a rectangular shape but could also be made as a square, round, or oval shape.

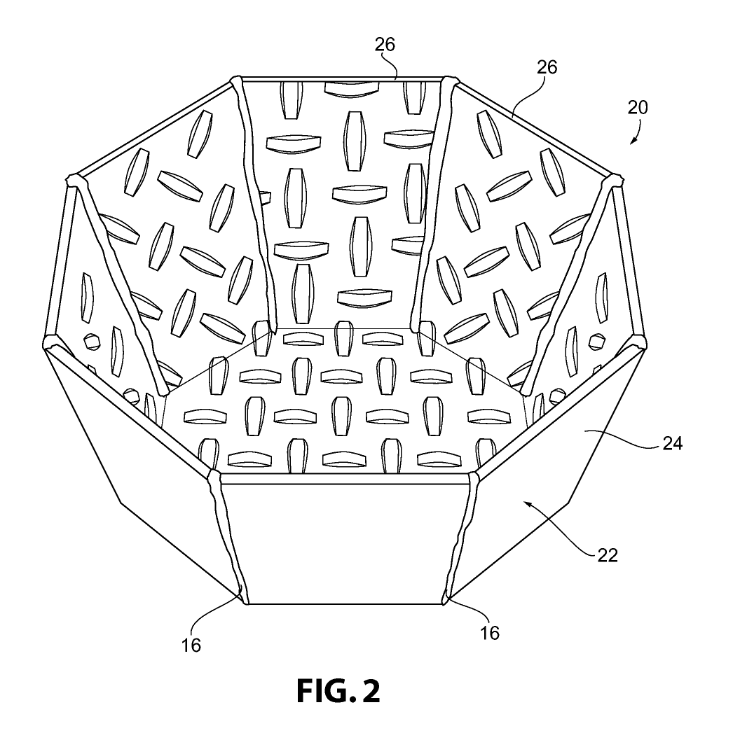

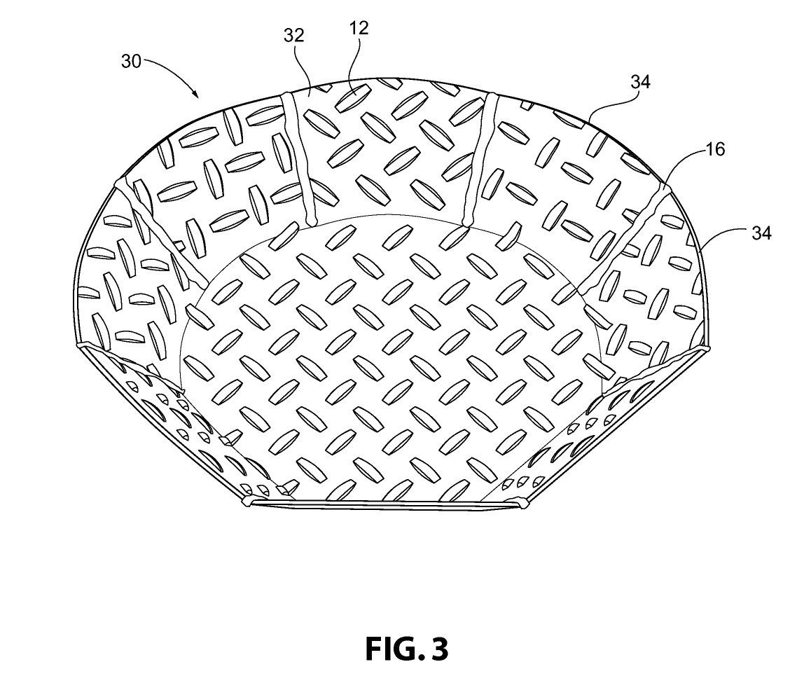

As shown in FIG. 1 as well as in FIGS. 2 and 3, the cookware in one presently preferred welded embodiment of the invention is made from a carbon steel plate having a tread plate debossed surface formed on the inside cooking surface. The debossed tread plate consists of a plurality of spaced-apart raised lugs 12 with flat surfaces 14 therebetween. During cooking, the raised lugs 12 support the food being cooked and to a large extent keep the food product from resting in the accumulated grease, fat, and oil accumulating in the lower flat areas 14. The raised lugs 12 also impart a pleasing seared pattern to the food product and improve the overall cooking experience. Post-cooking clean-up of the cookware is also improved because the raised lugs reduce sticking and scorching problems along the flat portions 14 of the cooking surface.

While the drawings of the cookware depicted in FIGS. 1-6 depict carbon steel as the presently preferred material used in making the cookware, as mentioned hereinabove, alternate materials could be used, such as aluminum or stainless steel tread plates.

Referring back to FIG. 1, the roasting pan 2 shown in the drawing is formed from a carbon steel tread plate between about 1/16 inch to about ¼ inch in thickness, preferably about ⅛ inch. A rectangular flat blank is first cut from the tread plate stock to the desired dimensions of the roasting pan 2. In the welded embodiments, the flat blank is then cut, preferably by a programmed laser, to form four corner cut lines in a pie shape from the flat cook surface 10 of the blank radially outward. The pie-shaped corner segments which are cut out and removed from the flat blank permit the subsequent bending and joining of the sidewalls of the cookware. The long sidewalls 4 and narrow sidewalls 6 are then bent upwardly to join adjacently at the cut out corners. Bending of the sidewalls 4 and 6 is preferably done in a press brake or like device due to the toughness of the carbon steel tread plate. After bending of the sidewalls, weld beads 16 are then applied along the joined edges of the adjacent sidewall seams to form a liquid-tight enclosure in the roasting pan 2. In FIG. 1, it will be seen that handles 8 are provided at each of the opposed narrow sidewalls 6. The handles are first formed when laser cutting the flat blank by providing additional material in the blank sufficient to form the extended handles. After the flat blank has been cut in this manner, the handles are then formed in the press brake by bending.

The formed and welded cookware can then be subjected to a deburring treatment, as by grinding, to remove any rough edges along the laser cut edges and along the weld seams 16. Surface rust (if present) is also removed and the carbon steel cookware is preferably subjected to a seasoning treatment or other coating to further protect the steel from corrosive attack and to improve cooking performance. Seasoning iron cookware is well known and may consist of coating the cookware with a mineral or vegetable oil or lard, and then thermally treating the coated article in an oven at elevated temperature. A presently preferred curing temperature is about 600° F. The cookware may alternatively be coated by an appropriate coating. The finished, cured, or otherwise coated surface of the carbon steel tread plate cookware is preferably black or in color. Black is aesthetically pleasing in appearance but, in addition, improves the radiant heat absorption properties of the cookware.

The cookware depicted in FIG. 2 is in the form of a saucepan 20, while a fry pan 30 is shown in FIG. 3, demonstrating some of the various welded embodiments of the cookware of the present invention. The finished saucepan 20 and fry pan 30 would also have handles attached (not shown). The handles could be stick style handles, for example, or loop handles, which would be attached to the sidewall(s) of the cookware, as by welding or by rivets, etc. By way of example and in no way limiting, the saucepan 20 is an octagon shape measuring about 8 inches in diameter and about 4-½ inches deep. It will be seen in FIG. 2 that the inner surface of the carbon steel tread plate on the cooking side carries the debossed tread plate pattern while the outer surfaces 24 of the sidewall segments 22 are flat. This is true in all of the cookware shown in FIGS. 1-3.

The fry pan 30 embodiment of FIG. 3 is also of an octagon shape, having eight sidewall segments 32 cut from a blank of carbon steel tread plate. The outer periphery of each of the sidewall segments 32 forming the top edge of the cookware may be cut from the flat blank in an arcuate shape so that the top edge or rim 34 of the fry pan 30 approximates a circular shape after bending and joining the sidewall segments 32 at welded seams 16. Such an arcuate shape is also applied to the top sidewall edges 26 of sidewall segments 22 of the saucepan 20 of FIG. 2.

The carbon steel saucepan 20 and carbon steel fry pan 30 are also preferably seasoned and thermally cured or otherwise coated as previously described to provide corrosion resistance and a pleasing black, radiant heat-absorbing surface. In addition, the seasoned and thermally cured cook surface or other coating provides increased stick resistance and easier clean-up than an unseasoned or uncoated article of carbon steel.

In one presently preferred embodiment of the tread plate used in making the cookware 2 shown in the drawings, the raised lugs 12 of the tread plate are each about ¾ inch long with a wider mid-portion of about ¼ inch wide, tapering to more narrow end portions having a width of about ⅛ inch. The lugs extend from the flat surface 14 of the cookware 2 to a height of about ⅛ inch with a substantially flat upper surface along the mid-portion extending to chamfered surfaces at the narrower end portions. The flat upper surface of the lugs engages the food being cooked. Of course, other raised lug configurations, such as a diamond shape, could be used without departing from the spirit of the present invention.

The longitudinal axes of the lugs 12 are preferably oriented at about 90° angles between adjacent lugs, wherein a narrower end portion of a lug is spaced from the mid portion of an adjacent lug by about ¼ inch. During cooking, the upper surfaces of the raised lugs 12 contact the food being cooked and transmit heat directly to the food by conduction and provide fast and even cooking to the food due to the evenly spaced-apart array of lugs 12. The lugs 12 also impart a visually pleasing seared pattern to the food being cooked, such as steaks, hamburgers, and the like.

As mentioned hereinabove, instead of using carbon steel as the tread plate material, aluminum tread plate or stainless steel tread plate may be used in making the cookware of the invention. Both aluminum and stainless steel tread plate are readily available commercially. Instead of seasoning the formed cookware as described above in connection with the carbon steel tread plate embodiments, the aluminum tread plate and stainless steel tread plate embodiments could be finished by polishing and/or by brushing the surfaces of the cookware to improve the appearance and non-stick properties thereof. These other metal tread plate materials may also be coated if desired.

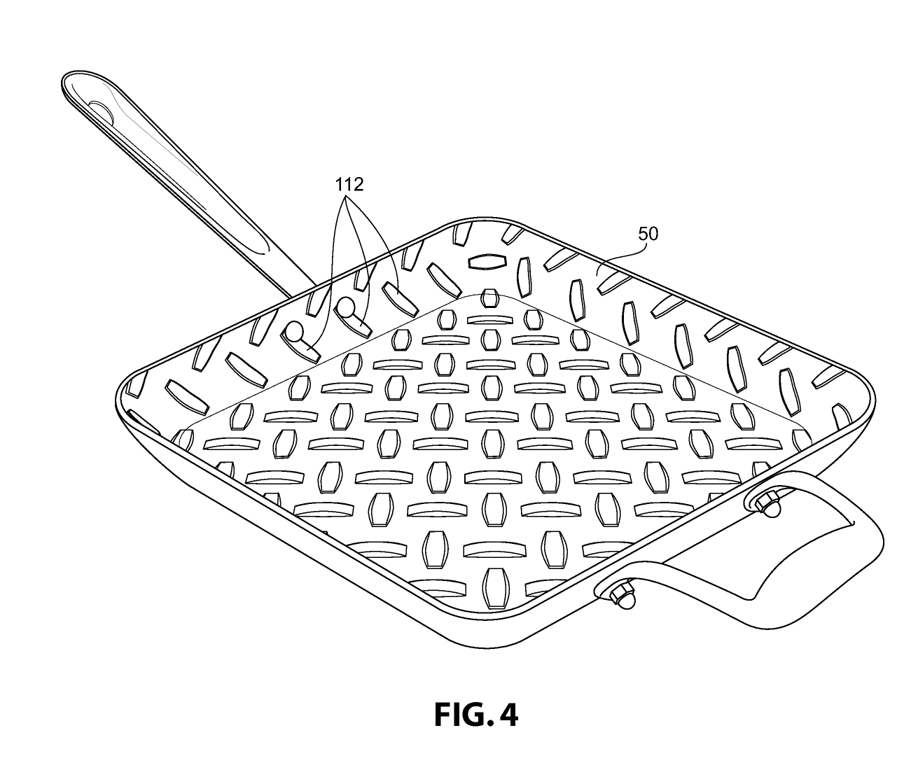

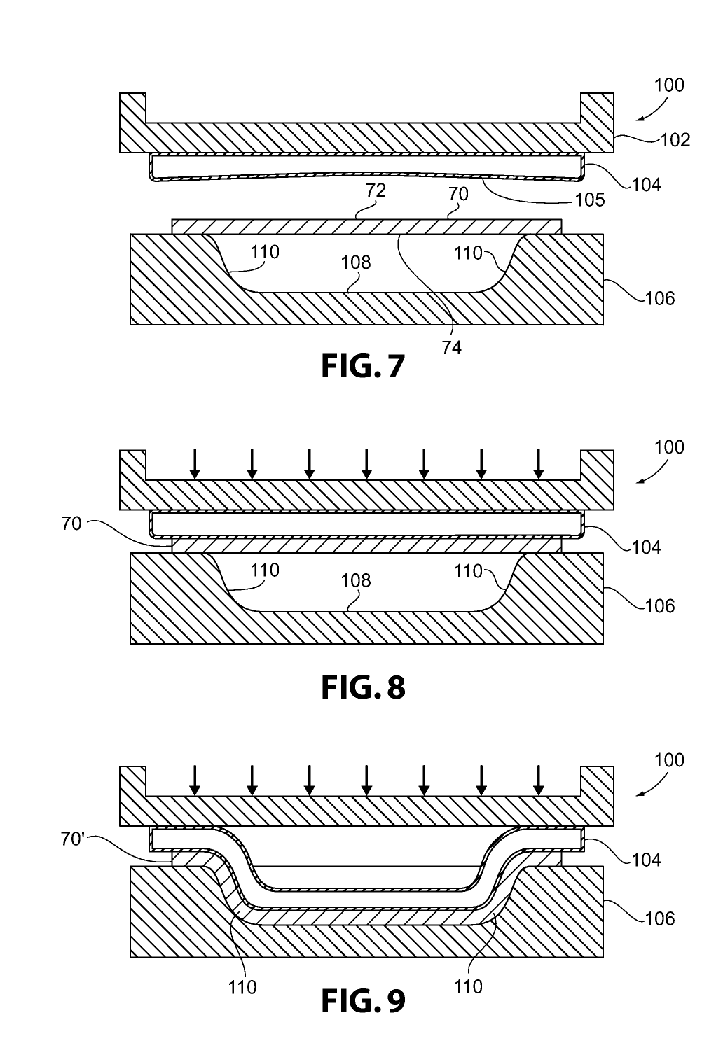

A further embodiment of the present invention will now be described with reference to FIGS. 4-9. The several cookware shapes depicted in FIGS. 4-6 are made by the blow-down hydro-forming apparatus depicted in FIGS. 7-9. The cookware articles shown in FIGS. 4-6 are formed from a flat blank of tread plate material 70 in the blow-down hydro-forming apparatus 100 shown in FIGS. 7-9. The hydro-forming press 100 is shown in an open position in FIG. 7. The upper portion 102 of the apparatus 100 carries a rubber bladder 104, the rear side of which communicates with a liquid hydraulic fluid for exerting hydraulic pressure when the apparatus is activated. The bottom side of the bladder 104 faces the blank 70 and may be equipped with a rubber wear pad 105 which is attached to the bottom face of the bladder as by an adhesive. The lower tool 106 has a cavity 108 formed therein in the desired shape of the cookware 50 or 60 shown in FIGS. 4-6.

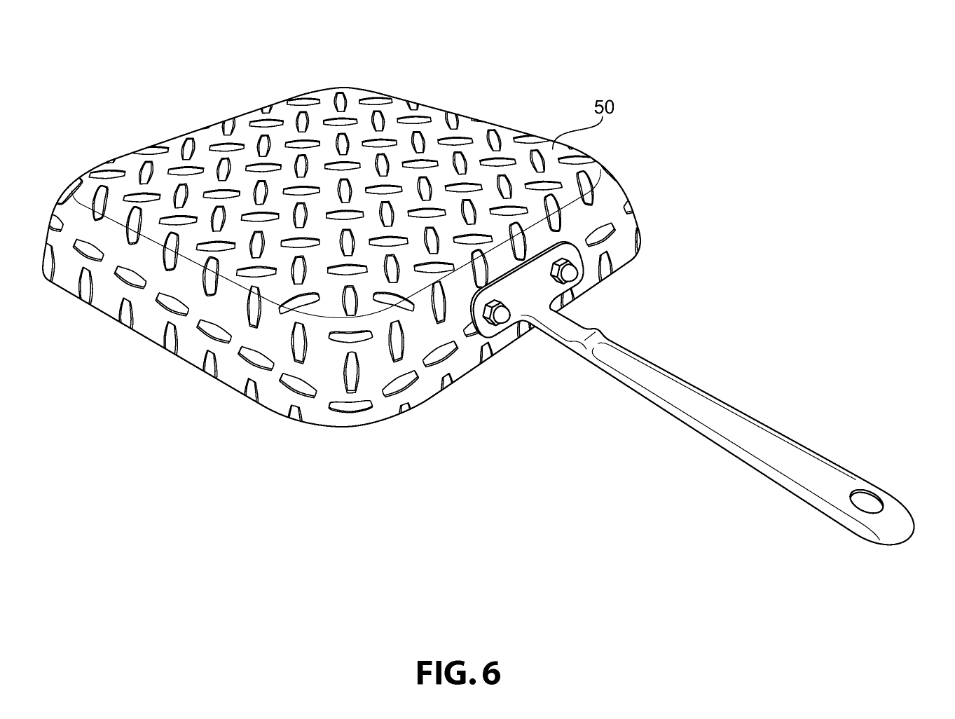

The blank 70 of the tread plate is pre-cut to a desired size for the cookware to be formed and placed above the cavity 108 of the tool 106 when the hydro-forming press 100 is in the open position, as shown in FIG. 7. When placing the blank 70, the “debossed” surface carrying the outwardly extending lugs face toward the bladder 104 and the other lower side 74 of the blank may have a flat surface of an embossed surface facing the cavity 108. In other words, the blank 70 has an upper debosed surface 72 which carries the outwardly extending lugs of the tread plate which will define the interior cooking surface of the formed cookware. The lower side 74 of the blank 70 is either flat or is the “embossed” side of the blank which will define the exterior side of the cookware, such as shown in the cookware 50 of FIG. 6. The cookware shown in FIGS. 4-6 were made from a different tread plate stock from the tread plate stock used in making the cookware of FIGS. 1-3. The tread plate of FIGS. 1-3 had a flat side on side 74 and a debossed side on the side 72. The tread plate blank 70 is debossed on cooking side 72 carrying the raised lugs where the other side 74 carries inwardly embossed lug shapes which match the debossed lugs on side 72. Such tread plate is made by rolling with textured male and female rolls which are geared to registered rotation so that each of the debossed and embossed lugs are formed simultaneously as the flat metal sheet passes between the rotating textured rolls. The manufacture of such double-sided tread plate is, in itself, well known in the art. The double-sided tread plate used in making the cookware in FIGS. 4-6 had a thickness of 0.100 inch.

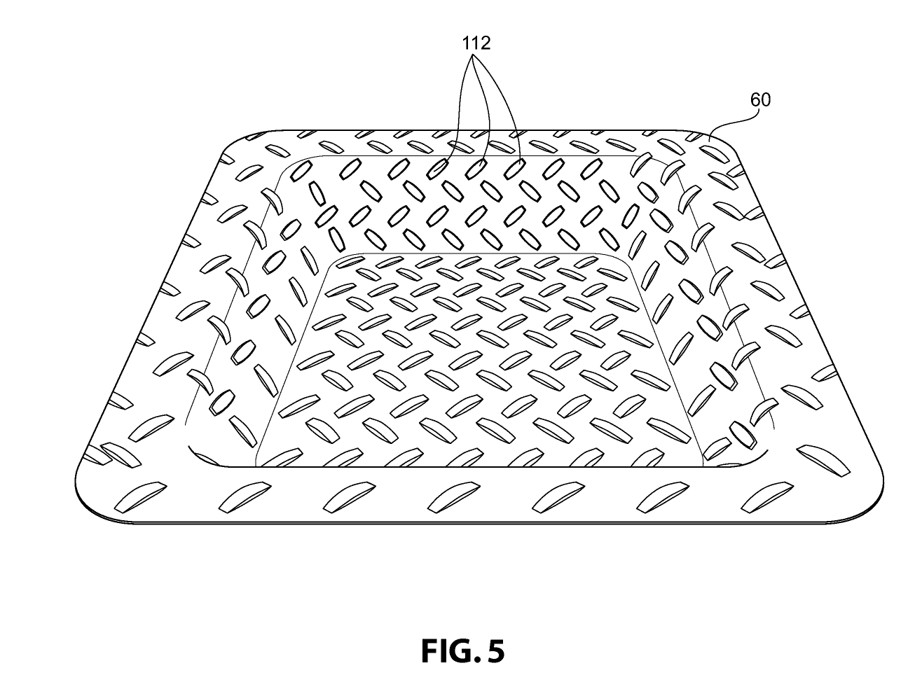

The orientation of the blank 70 relative to the cavity 108 is also important in order to decrease the possibility of rupturing the tread plate during the hydro-forming operation. The cavity 108 of the tool 106 has radiused corners 110 in the area transitioning between the flat bottom of the cavity to the sidewalls thereof. These corners 110 are subjected to a higher stress during hydro-forming than the remaining portions of the blank. In order to compensate for this, the blank 70 is oriented such that a row of upwardly extending lugs is positioned such that the lugs are at a substantially 45° angle relative to a longitudinal axis extending along each of the corners 110. In this manner, the higher stress caused by bending at the corners 110 occurs along the thicker material provided by the row of upwardly extending lugs and prevents rupture of the formed tread plate at the corners, see for example the oriented row of lugs 112 in the cookware shown in FIGS. 4 and 5.

The blow-down hydro-forming operation will now be explained in greater detail with reference to FIGS. 7-9. As stated above, the flat blank 70 of tread plate material is placed the hydro-forming apparatus 100 above the cavity 108 of the tool 106.

Also as stated, the blank 70 is oriented so that the raised lugs will be at a 45° angle relative to the corners 110 in the cavity 108. It should also be mentioned that the blank 70 used in the blow-down hydro-forming apparatus will be smaller than the blank used in the welded embodiment for the same size cookware since no cut-out portions are present in the hydro-forming embodiment, nor is the bending or welding steps required. Hence, less tread plate stock is used and less scrap is generated.

Continuing with the hydro-forming process, FIG. 8 shows the apparatus 100 in the closed position. At that point, the hydraulic fluid in the upper portion of the apparatus is energized to cause the rubber bladder to expand to forcibly engage the upper surface 72 of the blank 70. The hydraulic pressure causes the blank to deform into the shape of the tool cavity 108 as shown in FIG. 9 to produce a formed shape 70′ of cookware.

The shape 70′ can then be degresed if needed and cleaned to provide a suitable surface for the application of a coating to protect the carbon steel from rusting and to provide a non-stick cook surface. One type of such coating is a sol-gel ceramic sold by the Whiford Corporation under the Fusion brand.

Handles, such as the stick handle and the loop handle of FIG. 4, can also be attached to the cookware by welding, riveting, or bolting. A grip surface in the form of a flared edges 120 can also be formed during the hydro-forming operation, such grip surface flared edges 120 can be seen in FIG. 5.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

1. Cookware formed from a metal tread plate.

2. The cookware of claim 1, wherein the tread plate has a surface comprising a plurality of raised, spaced-apart lugs and forming a cooking surface of the cookware.

3. The cookware of claim 2, wherein the metal tread plate is one of carbon steel tread plate, stainless steel tread plate, or aluminum tread plate.

4. The cookware of claim 2, wherein the tread plate is carbon steel and has one of a cured surface or coating applied thereto.

5. The cookware of claim 4 in the form of a roasting pan, a saucepan, or a fry pan.

6. A method for making cookware comprising the steps of:
(a) providing a metal tread plate;
(b) cutting a flat blank from said tread plate in a desired pattern to form a desired shape, including a plurality of spaced-apart, cut sidewall segments, extending radially outward from a central flat uncut region;
(c) bending the cut sidewall segments of the blank upwardly from the central uncut region to contact the adjacent sidewall segments; and
(d) depositing weld seams at contacting edges of adjacent sidewall segments to provide a liquid-tight environment inside the cookware.

7. The method of claim 6, wherein the metal tread plate is one selected from carbon steel, stainless steel, or aluminum alloy.

8. The method of claim 6, wherein the metal tread plate is carbon steel and includes the further steps of curing the cookware by coating the cookware with a vegetable or animal-based oil or lard followed by heating the coated cookware to a desired temperature to cure the oil and provide a black surface finish to the cookware.

9. The method of claim 6, including the step of cutting integral handles from the flat blank, the handles outwardly extending from a top edge of a pair of opposed sidewall segments, said handles being formed by bending.

10. The method of claim 6, including the step of attaching one or more handles to the cookware.

11. A method for making cookware comprising the steps of:
(a) providing a metal tread plate;
(b) cutting a blank from the tread plate in a size for making a desired shape of cookware;
(c) forming the blank by hydro-forming into the desired shape of cookware.

12. The method of claim 11 wherein the metal tread plate is one of carbon steel, stainless steel, or aluminum.

13. The method of claim 12 wherein the formed cookware is subjected to a coating treatment to provide a non-stick surface and protection against corrosion.

14. The method of claim 13 wherein the tread plate is carbon steel.

15. The method of claim 13 wherein the coating is one of a sol-gel ceramic, ceramic, or vitreous enamel.

16. The method of claim 11 including a step of orientating the cut blank after blank cutting step (b) and prior to the forming step (c) so that a longitudinal axis of a row of raised lugs on the tread plate is at a substantially 45 angle relative to a bend portion of the formed cookware.
